(19) United States
(12) Patent Application Publication
(10) Pub. No.: US 2022/0319257 A1
(43) Pub. Date: Oct. 6, 2022

(54) AIRCRAFT MOTION OBSERVER CONFIGURED FOR USE IN ELECTRIC AIRCRAFT

(71) Applicant: BETA AIR, LLC, South Burlington, VT (US)

(72) Inventor: Nicholas Moy, Burlington, VT (US)

(73) Assignee: BETA AIR, LLC, South Burlington, VT (US)

(21) Appl. No.: 17/218,403

(22) Filed: Mar. 31, 2021

(51) Int. Cl. G07C 5/08; B64D 27/24; B64D 31/06

(52) U.S. Cl. CPC G07C 5/0816; B64D 27/24; B64D 31/06

(57) ABSTRACT

An aircraft motion observer configured for use in electric aircraft includes an actuator model configured to receive at least an aircraft command, wherein the aircraft command comprises a desired change in aircraft trajectory as a function of a plurality of flight components, generate a performance datum for the flight components as a function of the aircraft command. System includes a plant model configured to generate a predictive datum for the flight components as a function of the actuator model and the performance datum. System includes a sensor communicatively connected to the aircraft configured to detect a measured state datum. System includes a controller configured to compare the predictive datum and the measured state datum, generate an inconsistency datum wherein the inconsistency datum comprises a mathematical function to compensate for the difference between the predictive state datum and the measured state datum, and transmit the inconsistency datum to the plant model.

### FIELD OF THE INVENTION

The present invention generally relates to the field of aircraft control. In particular, the present invention is directed to an aircraft motion observer configured for use in electric aircraft.

### BACKGROUND

In electrically propelled vehicles, such as an electric vertical takeoff and landing (eVTOL) aircraft, it is essential to maintain the integrity of the aircraft until safe landing. In some flights, a component of the aircraft may experience a malfunction or failure which will put the aircraft in an unsafe mode which will compromise the safety of the aircraft, passengers and onboard cargo. A system and method for an aircraft motion observer configured for use in an electric aircraft is useful and necessary to control aircraft, in embodiments.

### SUMMARY OF THE DISCLOSURE

In an aspect an aircraft motion observer includes an actuator model, the actuator model configured to receive at least an aircraft command, wherein the aircraft command comprises a desired change in aircraft trajectory as a function of a plurality of flight components generate a performance datum for the plurality of flight components as a function of the at least an aircraft command. System includes a plant model, the plant model configured to generate a predictive datum for the plurality of flight components as a function of the actuator model and the performance datum. System includes at least a sensor communicatively coupled to the aircraft, the at least a sensor configured to detect a measured state datum System includes a controller, the controller configured to compare the predictive datum and the measured state datum and as a function of the comparing, generate an inconsistency datum wherein the inconsistency datum comprises a mathematical function to compensate for the difference between the predictive state datum and the measured state datum, and transmit the inconsistency datum to the plant model.

In another aspect, an aircraft motion observer configured for use in an electric aircraft includes receiving, at an actuator model, at least an aircraft command, generating, at the actuator model, a performance datum as a function of the at least an aircraft command, receiving, at a plant model, the performance datum, generating, at the plant model, a predictive datum as a function of the performance datum, detecting, at an at least a sensor, a measured state datum, receiving, at a controller, the predictive datum and the measured state datum, comparing, at the controller, the predictive datum and the measured state datum, generating, at the controller, an inconsistency datum as a function of the comparing of the predictive datum and the measured state datum, and transmitting the inconsistency datum to the plant model.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is an illustrative embodiment of a system for an aircraft motion observer configured for use in electric aircraft in block diagram form;

FIG. 2 is an illustrative schematic diagram of an integrator configured for use in embodiments of the present invention;

FIG. 3 is another illustrative embodiment of a system for an aircraft motion observer configured for use in electric aircraft in block diagram form;

FIG. 4 is an exemplary method of an aircraft motion observer configured for use in electric aircraft in block diagram form;

FIG. 5 is a block diagram of an exemplary embodiment of a machine-learning module;

FIG. 6 is an illustration of an embodiment of an electric aircraft; and

FIG. 7 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to an aircraft motion observer configured for use in electric aircraft. Aircraft motion observer includes an actuator model, the actuator model configured to receive at least an aircraft command, wherein the aircraft command comprises a desired change in aircraft trajectory as a function of a plurality of flight components, generate a performance datum for the plurality of flight components as a function of the at least an aircraft command. System includes a plant model, the plant model configured to generate a predictive datum for the plurality of flight components as a function of the actuator model and the performance datum. System includes at least a sensor communicatively coupled to the aircraft, the at least a sensor configured to detect a measured state datum System includes a controller, the controller configured to compare the predictive datum and the measured state datum and as a function of the comparing, generate an inconsistency datum wherein the inconsistency datum comprises a mathematical function to compensate for the difference between the predictive state datum and the measured state datum, and transmit the inconsistency datum to the plant model.

Aspects of the present disclosure can be used for an aircraft motion observer configured for use in an electric aircraft. In another aspect, an aircraft motion observer configured for use in an electric aircraft includes receiving, at an actuator model, at least an aircraft command, generating, at the actuator model, a performance datum as a function of the at least an aircraft command, receiving, at a plant model, the performance datum, generating, at the plant model, a predictive datum as a function of the performance datum, detecting, at an at least a sensor, a measured state datum, receiving, at a controller, the predictive datum and the measured state datum, comparing, at the controller, the predictive datum and the measured state datum, generating, at the controller, an inconsistency datum as a function of the comparing of the predictive datum and the measured state datum, and transmitting the inconsistency datum to the plant model.

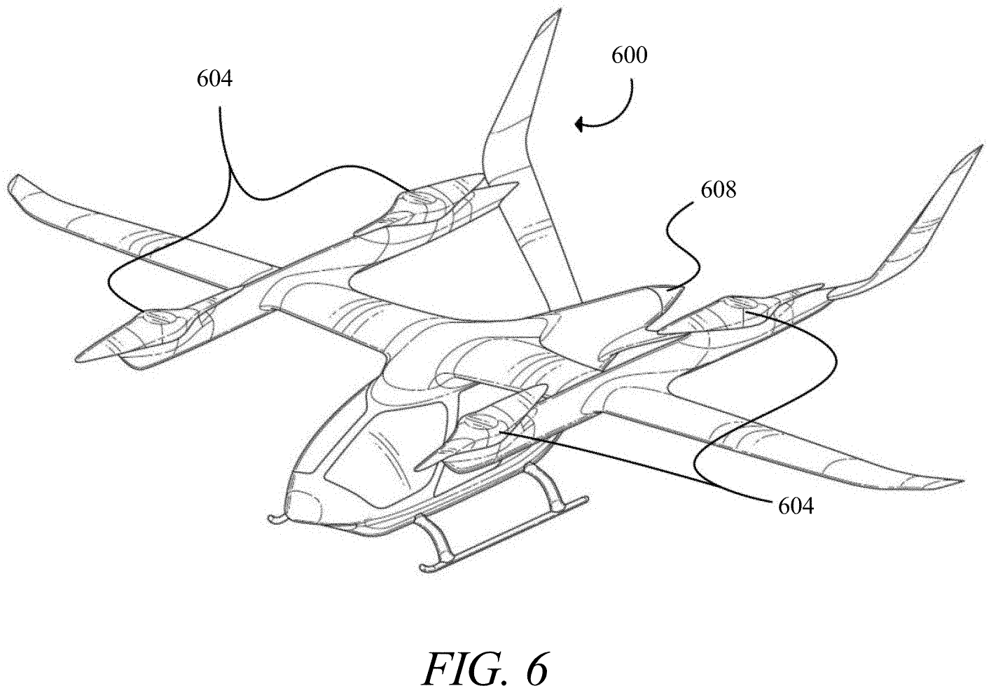

In the following description, for the purposes of explanation, numerous specific details are set forth in order to provide a thorough understanding of the present invention. It will be apparent, however, that the present invention may be practiced without these specific details. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to orientations as illustrated for exemplary purposes in FIG. 6. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply embodiments of the inventive concepts defined in the appended claims. Hence, specific dimensions and other physical characteristics relating to the embodiments disclosed herein are not to be considered as limiting, unless the claims expressly state otherwise.

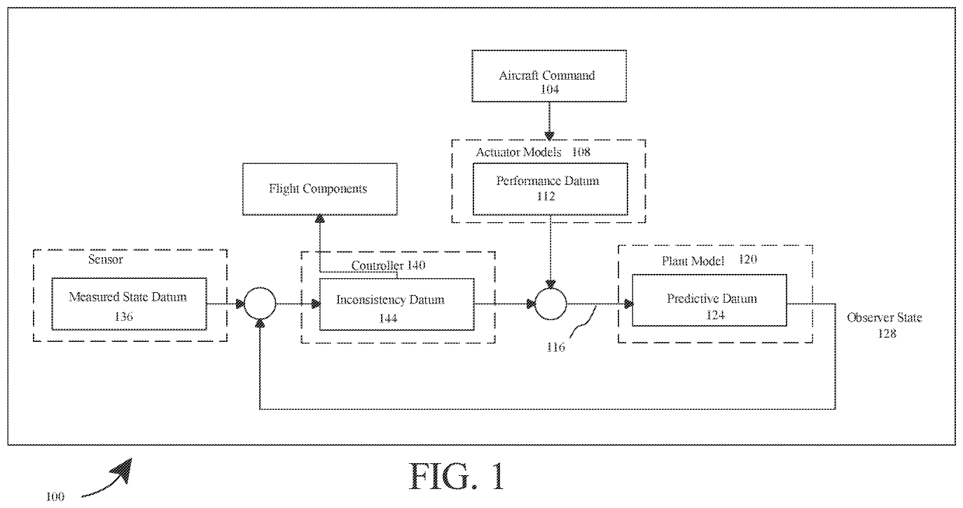

Referring now to FIG. 1, an exemplary embodiment of a motion observer 100 for an aircraft motion observer configured for use in electric aircraft is illustrated. A “motion observer”, for the purposes of this disclosure, is a system that provides an estimate of a state of a given real system, from measurements of the input and output of the real system. Motion observers are often used with feedback wherein physical states of the system cannot easily be determined by direct observation. A system can be indirectly observed from effects on the state as measured outputs. One or more components of motion observer 100, as described in further detail below, may be implemented using one or more computing devices, including without limitation a module and/or component including a computing device and/or a module and/or component implemented by programming a computing device; multiple modules and/or components may be components of a single computing device. A computing device may include any computing device as described in this disclosure, including without limitation a microcontroller, microprocessor, digital signal processor (DSP) and/or system on a chip (SoC) as described in this disclosure. Computing devices may include, be included in, and/or communicate with a mobile device such as a mobile telephone or smartphone. A computing device may include a single computing device operating independently, or may include two or more computing device operating in concert, in parallel, sequentially or the like; two or more computing devices may be included together in a single computing device or in two or more computing devices. A computing device may interface or communicate with one or more additional devices as described below in further detail via a network interface device. Network interface device may be utilized for connecting a computing device and/or other component to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. A computing device and/or one or more modules and/or components disclosed in this disclosure may include but is not limited to, for example, a computing device or cluster of computing devices in a first location and a second computing device or cluster of computing devices in a second location. A computing device and/or one or more modules and/or components disclosed in this disclosure may include one or more computing devices dedicated to data storage, security, distribution of traffic for load balancing, and the like. A computing device and/or one or more modules and/or components disclosed in this disclosure may distribute one or more computing tasks as described below across a plurality of computing devices of computing device, which may operate in parallel, in series, redundantly, or in any other manner used for distribution of tasks or memory between computing devices. A computing device and/or one or more modules and/or components disclosed in this disclosure may be implemented using a “shared nothing” architecture in which data is cached at the worker, in an embodiment, this may enable scalability of a computing device and/or one or more modules and/or components disclosed in this disclosure and/or computing device.

With continued reference to FIG. 1, a computing device and/or one or more modules and/or components disclosed in this disclosure may be designed and/or configured to perform any method, method step, or sequence of method steps in any embodiment described in this disclosure, in any order and with any degree of repetition. For instance, a computing device and/or one or more modules and/or components disclosed in this disclosure may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device and/or one or more modules and/or components disclosed in this disclosure may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, motion observer 100 includes actuator model 108 configured to receive at least an aircraft command 104, wherein the aircraft command 104 includes a desired change in aircraft trajectory as a function of a plurality of flight components. “Flight components”, for the purposes of this disclosure, includes components related to, and mechanically coupled to an aircraft that manipulates a fluid medium in order to propel and maneuver the aircraft through the fluid medium. The operation of the aircraft through the fluid medium will be discussed at greater length hereinbelow. At least an aircraft command 104 may include information gathered by one or more sensors.

One or more sensors may be communicatively coupled to at least a pilot control, the manipulation of which, may constitute at least an aircraft command. “Communicative connecting”, for the purposes of this disclosure, refers to two or more components electrically, or otherwise connected and configured to transmit and receive signals from one another. Signals may include electrical, electromagnetic, visual, audio, radio waves, or another undisclosed signal type alone or in combination. At least a sensor communicatively connected to at least a pilot control may include a sensor disposed on, near, around or within at least pilot control. At least a sensor may include a motion sensor. “Motion sensor”, for the purposes of this disclosure refers to a device or component configured to detect physical movement of an object or grouping of objects. One of ordinary skill in the art would appreciate, after reviewing the entirety of this disclosure, that motion may include a plurality of types including but not limited to: spinning, rotating, oscillating, gyrating, jumping, sliding, reciprocating, or the like. At least a sensor may include, torque sensor, gyroscope, accelerometer, torque sensor, magnetometer, inertial measurement unit (IMU), pressure sensor, force sensor, proximity sensor, displacement sensor, vibration sensor, among others. At least a sensor 104 may include a sensor suite which may include a plurality of sensors that may detect similar or unique phenomena. For example, in a non-limiting embodiment, sensor suite may include a plurality of accelerometers, a mixture of accelerometers and gyroscopes, or a mixture of an accelerometer, gyroscope, and torque sensor. The herein disclosed system and method may comprise a plurality of sensors in the form of individual sensors or a sensor suite working in tandem or individually. A sensor suite may include a plurality of independent sensors, as described herein, where any number of the described sensors may be used to detect any number of physical or electrical quantities associated with an aircraft power system or an electrical energy storage system. Independent sensors may include separate sensors measuring physical or electrical quantities that may be powered by and/or in communication with circuits independently, where each may signal sensor output to a control circuit such as a user graphical interface. In an embodiment, use of a plurality of independent sensors may result in redundancy configured to employ more than one sensor that measures the same phenomenon, those sensors being of the same type, a combination of, or another type of sensor not disclosed, so that in the event one sensor fails, the ability to detect phenomenon is maintained and in a non-limiting example, a user alter aircraft usage pursuant to sensor readings. At least a sensor may be configured to detect pilot input from at least pilot control. At least pilot control may include a throttle lever, inceptor stick, collective pitch control, steering wheel, brake pedals, pedal controls, toggles, joystick. One of ordinary skill in the art, upon reading the entirety of this disclosure would appreciate the variety of pilot input controls that may be present in an electric aircraft consistent with the present disclosure. Inceptor stick may be consistent with disclosure of inceptor stick in U.S. Pat. application Ser. No. 17/001,845 and titled “A HOVER AND THRUST CONTROL ASSEMBLY FOR DUAL-MODE AIRCRAFT”, which is incorporated herein by reference in its entirety. Collective pitch control may be consistent with disclosure of collective pitch control in U.S. Pat. application Ser. No. 16/929,206 and titled “HOVER AND THRUST CONTROL ASSEMBLY FOR DUAL-MODE AIRCRAFT”, which is incorporated herein by reference in its entirety. At least pilot control may be physically located in the cockpit of the aircraft or remotely located outside of the aircraft in another location communicatively connected to at least a portion of the aircraft. “Communicatively connect”, for the purposes of this disclosure, is a process whereby one device, component, or circuit is able to receive data from and/or transmit data to another device, component, or circuit; communicative connecting may be performed by wired or wireless electronic communication, either directly or by way of one or more intervening devices or components. In an embodiment, communicative connecting includes electrically coupling an output of one device, component, or circuit to an input of another device, component, or circuit. Communicative connecting may be performed via a bus or other facility for intercommunication between elements of a computing device. Communicative connecting may include indirect connections via “wireless” connection, low power wide area network, radio communication, optical communication, magnetic, capacitive, or optical coupling, or the like. At least pilot control may include buttons, switches, or other binary inputs in addition to, or alternatively than digital controls about which a plurality of inputs may be received. At least pilot control may be configured to receive pilot input. Pilot input may include a physical manipulation of a control like a pilot using a hand and arm to push or pull a lever, or a pilot using a finger to manipulate a switch. Pilot input may include a voice command by a pilot to a microphone and computing system consistent with the entirety of this disclosure. One of ordinary skill in the art, after reviewing the entirety of this disclosure, would appreciate that this is a non-exhaustive list of components and interactions thereof that may include, represent, or constitute, at least an aircraft command 104.

With continued reference to FIG. 1, at least a sensor may be configured to generate, as a function of pilot input, at least an aircraft command. At least an aircraft command 104 may include a command datum. A “command datum”, for the purposes of this disclosure, is an electronic signal representing at least an element of data correlated to pilot desire representing a desired change in aircraft conditions as described in the entirety of this disclosure. A “datum”, for the purposes of this disclosure, refers to at least an element of data identifying and/or a pilot input or command. At least pilot control may be communicatively connected to any other component presented in system, the communicative connection may include redundant connections configured to safeguard against single-point failure. Pilot input may indicate a pilot's desire to change the heading or trim of an electric aircraft. Pilot input may indicate a pilot's desire to change an aircraft's pitch, roll, yaw, or throttle. Aircraft trajectory is manipulated by one or more control surfaces and propulsors working alone or in tandem consistent with the entirety of this disclosure, hereinbelow. “Pitch”, for the purposes of this disclosure refers to an aircraft's angle of attack, that is the difference between the aircraft's nose and the horizontal flight trajectory. For example, an aircraft pitches “up” when its nose is angled upward compared to horizontal flight, like in a climb maneuver. In another example, the aircraft pitches “down”, when its nose is angled downward compared to horizontal flight, like in a dive maneuver. When angle of attack is not an acceptable input to any system disclosed herein, proxies may be used such as pilot controls, remote controls, or sensor levels, such as true airspeed sensors, pitot tubes, pneumatic/hydraulic sensors, and the like. “Roll” for the purposes of this disclosure, refers to an aircraft's position about its longitudinal axis, that is to say that when an aircraft rotates about its axis from its tail to its nose, and one side rolls upward, like in a banking maneuver. “Yaw”, for the purposes of this disclosure, refers to an aircraft's turn angle, when an aircraft rotates about an imaginary vertical axis intersecting the center of the earth and the fuselage of the aircraft. “Throttle”, for the purposes of this disclosure, refers to an aircraft outputting an amount of thrust from a propulsor. Pilot input, when referring to throttle, may refer to a pilot's desire to increase or decrease thrust produced by at least a propulsor. At least an aircraft command 104 may include an electrical signal. At least an aircraft command 104 may include mechanical movement of any throttle consistent with the entirety of this disclosure. Electrical signals may include analog signals, digital signals, periodic or aperiodic signal, step signals, unit impulse signal, unit ramp signal, unit parabolic signal, signum function, exponential signal, rectangular signal, triangular signal, sinusoidal signal, sinc function, or pulse width modulated signal. At least a sensor may include circuitry, computing devices, electronic components or a combination thereof that translates pilot input into at least an aircraft command 104 configured to be transmitted to another electronic component.

With continued reference to FIG. 1, motion observer 100 includes actuator model 108 configured to generate performance datum 112 for the plurality of flight components as a function of the at least an aircraft command 104. Actuator model 108 is configured to model the effect of a fluid medium on each of the plurality of flight components through the full range of motion of each of the plurality of flight components. Actuator model 108 may include a mathematical model of the dynamics of each of the plurality of flight components. Actuator model 108 may perform and/or implement analysis utilizing fluid mechanics. In an embodiment and without limitation, actuator 108 may perform and/or implement computational flow dynamic (CFD) analysis wherein one or more computing devices simulate the flow of a fluid comprising adjustable parameters and the resultant forces and torques on each of the plurality of bodies present in simulation. For the purposes of this disclosure, CFD analysis may include any computer analysis including physics-based simulation of fluid flows over solid bodies. For example, and without limitation, for each of the plurality of flight components desired to be modeled, CFD analysis may be employed at a plurality of operating points. “Operating points”, for the purposes of this disclosure, are modeled positions of a flight component subject to CFD analysis, for example, one operating point may be the neutral position of a flight component and a second operating point of the same flight component may be the maximum deflected position. CFD analysis may be employed at any number of operating points, either manually, automatedly, or a combination thereof. One of ordinary skill in the art would appreciate, after reviewing the entirety of this disclosure, the near limitless arrangement and systems of storing the plurality of data generated as a result of actuator model 108. For example, and without limitation, matrices, columns, rows, vectors, tables, databases, datastores, and the like may store data as raw data, prepare date for manipulation or conditioning, or another operation or combination of operations for use in the system herein described. Actuator model 108 may be a separate model than the hereinbelow described plant model as it simplifies the plant model for the herein disclosed reasons, at least. Actuator model 108 may generate resultant torques, forces, moments, the components thereof in three-dimensional space, the cumulative force and/or torque on an aircraft as a whole, or another combination of outputs. Actuator model 108 may include information regarding aircraft trajectory as it relates to torques and forces. For example, and without limitation, actuator model 108 may output resultant torque on an airfoil section of a wing with a flap, that changes aircraft's trajectory with respect to pitch, roll, and yaw. Pitch, roll, and yaw are consistent with any description of pitch, roll, and yaw in the entirety of this disclosure. An aircraft's “trajectory”, for the purposes of this disclosure, is the flight path that an object with mass in motion follows through space as a function of time. Actuator model 108 may include the geometry of any flight component as described herein, and in non-limiting embodiments, include geometry of any flight component or combination thereof not listed herein. Flight component geometry, for the purposes of this disclosure, may include suitable 3D computer aided design models, structures, two-dimensional drawings, engineering drawings, technical drawings, lofting drawings, sets of points in space, parameters of structures herein described like weight, mass, density, and the like, among others.

With continued reference to FIG. 1, actuator model 108 is configured to generate performance datum 112 for the plurality of flight components as a function of the at least an aircraft command. A “performance datum”, for the purposes of this disclosure, is a mathematical datum or set of data that presents the resultant forces, torques, or other interactions between the plurality of flight components and the fluid flow in order to predict the behavior of the flight components during performance. Performance datum 112 may be represented by one or more numbers, values, matrices, vectors, mathematical expressions, or the like for use in one or more components of system 100. Performance datum 112 may be an electrical signal capable of use by one or more components of system 100. Performance datum 112 may be an analog or digital signal. Motion observer 100 may include electronics, electrical components, or circuits configured to condition signals for use between one or more components present within system like analog to digital converters (ADC), digital to analog converters (DAC), and the like.

With continued reference to FIG. 1, actuator model 108 may be configured to model an actuator which may be communicatively and/or mechanically connected to one or more flight components, propulsors, and/or control surfaces of an aircraft; the actuator may physically move or cause to move the one or more flight components, propulsors, and/or control surfaces. An actuator may include a piston and cylinder system configured to utilize hydraulic pressure to extend and retract a piston coupled to at least a portion of electric aircraft. An actuator may include a stepper motor or server motor configured to utilize electrical energy into electromagnetic movement of a rotor in a stator. An actuator may include a system of gears coupled to an electric motor configured to convert electrical energy into kinetic energy and mechanical movement through a system of gears. An actuator may include components, processors, computing devices, or the like configured to detect at least an aircraft command 104. An actuator may be configured to receive at least an aircraft command 104 from flight controller, controller, one or more computing devices, or any other electronic component or aircraft component as described herein. An actuator may be configured to move at least a portion of the electric aircraft as a function of the at least an aircraft command 104. At least an aircraft command 104 indicates a desired change in aircraft heading or thrust, flight controller translates pilot input. That is to say that flight controller may be configured to translate a pilot input, in the form of moving an inceptor stick, for example, into electrical signals to at least an actuator that in turn, moves at least a portion of the aircraft in a way that manipulates a fluid medium, like air, to accomplish the pilot's desired maneuver. At least a portion of the aircraft that an actuator moves may be a control surface. An actuator, or any portion of an electric aircraft may include one or more flight controllers configured to perform any of the operations described herein and communicate with each of the other flight controllers, controllers, and other portions of an electric aircraft.

Further referring to FIG. 1, an actuator may be configured to move control surfaces of the aircraft in one or both of its two main modes of locomotion or adjust thrust produced at any of the propulsors. These electronic signals can be translated to aircraft control surfaces. These control surfaces, in conjunction with forces induced by environment and propulsion systems, are configured to move the aircraft through a fluid medium, an example of which is air. A “control surface” as described herein, is any form of a mechanical/hydraulic/pneumatic/electronic/electromechanical linkage with a surface area that interacts with forces to move an aircraft. A control surface may include, as a non-limiting example, ailerons, flaps, leading edge flaps, rudders, elevators, spoilers, slats, blades, stabilizers, stabilators, airfoils, a combination thereof, or any other mechanical surface are used to control an aircraft in a fluid medium. Persons skilled in the art, upon reviewing the entirety of this disclosure, will be aware of various mechanical linkages that may be used as a control surface, as used and described in this disclosure.

In an embodiment, and still referring to FIG. 1, an actuator may be mechanically coupled to a control surface at a first end and mechanically coupled to an aircraft, which may include any aircraft as described in this disclosure at a second end. As used herein, a person of ordinary skill in the art would understand “mechanically coupled” to mean that at least a portion of a device, component, or circuit is connected to at least a portion of the aircraft via a mechanical coupling. Said mechanical coupling can include, for example, rigid coupling, such as beam coupling, bellows coupling, bushed pin coupling, constant velocity, split-muff coupling, diaphragm coupling, disc coupling, donut coupling, elastic coupling, flexible coupling, fluid coupling, gear coupling, grid coupling, hirth joints, hydrodynamic coupling, jaw coupling, magnetic coupling, Oldham coupling, sleeve coupling, tapered shaft lock, twin spring coupling, rag joint coupling, universal joints, or any combination thereof. In an embodiment, mechanical coupling can be used to connect the ends of adjacent parts and/or objects of an electric aircraft. Further, in an embodiment, mechanical coupling can be used to join two pieces of rotating electric aircraft components. Control surfaces may each include any portion of an aircraft that can be moved or adjusted to affect altitude, airspeed velocity, groundspeed velocity or direction during flight. For example, control surfaces may include a component used to affect the aircrafts' roll and pitch which may comprise one or more ailerons, defined herein as hinged surfaces which form part of the trailing edge of each wing in a fixed wing aircraft, and which may be moved via mechanical means such as without limitation servomotors, mechanical linkages, or the like, to name a few. As a further example, control surfaces may include a rudder, which may include, without limitation, a segmented rudder. The rudder may function, without limitation, to control yaw of an aircraft. Also, control surfaces may include other flight control surfaces such as propulsors, rotating flight controls, or any other structural features which can adjust the movement of the aircraft.

With continued reference to FIG. 1, actuator model 108 may be configured to generate, partially, or fully contribute to feedforward term 116. Feedforward term 116 may include any data taken into the below-disclosed plant model 120 such as pilot or user commands, environmental data, or any and all modeled parameters, such as actuator model 108 outputs. A “feedforward term”, for the purposes of this disclosure, is any and all terms within a control diagram that proceeds forward in a control loop instead of backwards. In a non-limiting example, actuator model 108 may be configured to generate at least a portion of feedforward term 116. Feedforward term 116 may include, in a non-limiting example, at least an aircraft command 104, any and all data produced by actuator model 108, and/or performance parameter 112. With feedforward control, the disturbances are measured and accounted for before they have time to affect the system. In an example, such as a house thermostat as described above, a feed-forward system may measure the fact that the door is opened and automatically turn on the heater before the house can get too cold. Feed-forward control may be effective where effects of the disturbances on the system must be accurately predicted. For instance, if a window was opened that was not being measured, a feed-forward-controlled thermostat might let the house cool down. A feedforward control system may operate faster than a feedback control system, which differs from the former in that it includes both feedforward signals and feedback signals. However, feedback control systems may generally be more controllable and more accurate because of an ability to compare control outputs to sensed inputs using feedback signals, which permits modification of the latter to minimize error based on comparison. An observer is a feedback system that modifies a model used in feedforward control to account for sources of error that a feedback loop would otherwise detect. This may produce a system that has the speed advantages of feedforward control without sacrificing the controllability and/or of feedback control; the motion observer itself may be taught using a feedback loop, for instance and without limitation as described in this disclosure.

With continued reference to FIG. 1, motion observer 100 includes plant model 120 configured to generate a predictive datum 124 for the plurality of flight components as a function of the actuator model 108 and the performance datum 112. Plant model 120 includes a mathematical model of the torque produced on the electric aircraft when computational fluid dynamics are applied to the plurality of flight components. A “plant model”, for the purposes of this disclosure, is a component of control theory which includes a process and an actuator. A plant is often referred to with a transfer function which indicates the relation between an input signal and the output signal of a system without feedback, commonly determined by physical properties of the system. In a system with feedback, as in illustrative embodiments, herein described, the plant still has the same transfer function, but a control unit and a feedback loop, which possess their own transfer functions, are added to the system. Plant model 120 may include one or more computer models representing rigid body mechanics, rigid body dynamics, or a combination thereof. A “rigid body”, for the purposes of this disclosure, is a solid body in which deformation is zero or so small it can be neglected. For example, the distance between any two given points on a rigid body remains constant in time regardless of the external forces or moments exerted on it. Additionally, a rigid body is usually considered as a continuous distribution of mass. The position, kinematic, and kinetic quantities describing the motion of a rigid body include linear and angular components, respectively.

With continued reference to FIG. 1, plant model 120 may include a Newton Euler computational flow dynamic model (CFD). A Newton Euler CFD may include a model in which a plurality of flows may be simulated over a plurality of flight components over the entire range of motion of the flight components and the resultant torques and forces generated therefrom may be modeled. CFD analysis may be the same or similar to CFD analysis described in this disclosure with regard to actuator model 108. Flight components used in a Newton Euler CFD may be any of the flight components as described in this disclosure, including but not limited to, actuators, control surfaces, geometries related to an aircraft, and the like, among others. The “flows” for the purposes of this disclosure, is the flow of a liquid or gas over a physical body with a volume. Flows may include any fluid with the necessary viscosity to flow over a solid body. Flow may include inviscid flow, turbulent flow, incompressible flow, compressible flow, and laminar flow, among others. CFD analysis may also include and/or model resultant torques and forces on an aircraft in one or more orientations with respect to flow. “Laminar flow”, for the purposes of this disclosure, is characterized by fluid particles following smooth paths in layers, with each layer moving smoothly past the adjacent layers with little or no mixing. “Turbulent flow”, for the purposes of this disclosure, is fluid motion characterized by chaotic changes in pressure and flow velocity; this may represent a contrast to a laminar flow, which occurs when a fluid flows in parallel layers, with no disruption between those layers. “Inviscid flow”, for the purposes of this disclosure, is the flow of an inviscid fluid, in which the viscosity of the fluid is equal to zero. “Incompressible flow”, for the purposes of this disclosure, is a flow in which the material density is constant within a fluid parcel—an infinitesimal volume that moves with the flow velocity. An equivalent statement that implies incompressibility is that the divergence of the flow velocity is zero. “Compressible flow”, for the purposes of this disclosure, is a flow having a significant change in fluid density. While all flows are compressible in real life, flows may be treated as being incompressible when the Mach number is below 0.3.

With continued reference to FIG. 1, plant model 120 is configured to generate predictive datum 124. A “predictive datum”, for the purposes of this disclosure, is one or more elements of data representing the reaction of the rigid body representing an electric aircraft based on the actuator model and performance datum. Predictive datum 124 may be one or more vectors, coordinates, torques, forces, moments, or the like that represent the predicted movement or position of the rigid body subject to the model fluid dynamics as a function of the performance datum. Predictive datum 124 may include, be correlated with, or be the data presenting movement, velocities, or torques on the rigid body after application of fluid flows. Predictive datum 124 may be generated as a function of angle of attack (AoA). “Angle of attack”, for the purposes of this disclosure, is the relative angle between a reference line on a body (herein the rigid body), and the vector representing the relative motion between the body and the fluid through which it is moving. In other words, angle of attack, is the angle between the body's reference line and the oncoming flow. The reference line may include the farthest two points on the rigid body such that the line approximates the length of the rigid body. In the context or airfoils, the reference line may be the chord line, which connects the leading edge and the trailing edge of the airfoil. Plant model 120 may be configured to generate predictive datum 124 as a function of a signal from at least a flight component. A signal may include a position of one or more flight components such as control surfaces, throttle position, propulsor output, any datum associated with the aircraft, and any pilot command datum as described herein, among others. In situations where angle of attack is not useful, not available, or in general when it is not advantageous to use angle of attack as an input to the plant model 120, throttle position and/or a signal from one of the plurality of flight components may be used as a proxy. There may be data that correlates throttle position to angle of attack and/or airspeed that may be used as a suitable input to plant model 120. Airspeed may also be used as a suitable proxy for flow types in certain situations where other parameters are unavailable. Airspeed may be used separately or in combination with other inputs. An “airspeed”, for the purposes of this disclosure, is the speed of a body moving through the fluid relative to the fluid. The throttle may be consistent with any throttle or other pilot control as discussed herein. This in no way precludes the use of other proxies for plant model 120 inputs such as collective pitch or other pilot inputs alone or in combination.

With continued reference to FIG. 1, plant model 120 may be configured to utilize dynamic modeling. In an embodiment and without limitation, plant model 120 may be configured to utilize quaternion control. Plant model 120 may include one or more mathematical models utilizing the same or differing method of control. Any one or combination of any components in the herein disclosed motion observer 100 may utilize differing methods of control alone or in combination. For example, and without limitation, controller 140 and/or plant model 120 may utilize differing methods of control for certain real-world conditions, such as unusual attitude behavior, certain ranges of yaw, angle of attack, rates of movement such as rapid pitch angle change, or the like. A method of control may utilize one or more inputs specific to the method such as yaw angle, yaw angle rate of change, or the like. “Quaternions”, for the purposes of this disclosure are mathematical expressions of the form a+bi+cj+dk, where i, j, and k may represent unit vectors pointing along axes in three-dimensional Cartesian space. Quaternions may be used to represent rotation. A “unit quaternion” is a quaternion of unit length, i.e. a quaternion of form

$$\frac{q}{{‖ q ‖}^{2}}$$

where ∥q∥ is a norm representing a length of a quaternion q. Unit quaternions may also be called rotation quaternions as they may represent a 3D rotation group as described below. In 3-dimensional space, according to Euler's rotation theorem, any rotation or sequence of rotations of a rigid body or coordinate system about a fixed point may be treated as equivalent to a single rotation by a given angle about a fixed axis (called the Euler axis) that runs through the fixed point. An Euler axis may typically be represented by a unit vector u→. Therefore, any rotation in three dimensions may be represented as a combination of a vector u→ and a scalar. Quaternions may provide a simple way to encode this axis—angle representation in four numbers, and may be used to apply the corresponding rotation to a position vector, representing a point relative to the origin in R³. Euclidean vectors such as (2, 3, 4) or (aₓ, a_{y}, a_{z}) may be rewritten as 2i+3j+4k or aₓi+a_{y}j+a_{z}k, where i, j, k are unit vectors representing the three Cartesian axes (traditionally x, y, z), and also obey multiplication rules of fundamental unit quaternion. Unit quaternions may represent an algebraic group of Euclidean rotations in three dimensions in a straightforward way.

With continued reference to FIG. 1, an aircraft quaternion control may be a control system that uses quaternions to model motion in three dimensions, and more specifically, in the three attitude components of aircraft orientation, pitch, roll, and yaw. Quaternions used in quaternion aircraft control may be any of the quaternions discussed herein. Quaternion control may be useful in the field of aircraft control as a quaternion is a 4-dimensional vector used to describe the transformation of a vehicle in 3-dimensions. The use of quaternions may be favored over other descriptors due to their non-singularity properties at any aircraft attitude. Traditional aeronautic transformations (Euler angles), may be hindered by a phenomenon known as gimbal lock. Gimbal lock may cause a loss of degree of freedom (DOF) which could lead to controller instability. Since this thesis explores aggressive flight regimes, a quaternion attitude descriptor was chosen to provide a singularity-free rotation from hover to horizontal flight.

With continued reference to FIG. 1, plant model outputs an observer state 128. Observer state 128 may characterize the predictive datum 124 for further use in system 100. Observer state 128 may be consistent with the output discussed earlier in regard to aircraft motion observers. Observer state 128 may include predicted modeled behavior of the rigid body from plant model 120 and performance datum 112 from actuator model 108 modeling actuators attached to the plurality of flight components, all as a function of the at least an aircraft command 104. Observer state 128 may include one or more elements of data representing physical quantities of the modeled rigid body and actuators as a function of the at least an aircraft command 104. Observer state 128 may consolidate outputs of previous components of motion observer 100 such as predictive datum 124 and at least an aircraft command 104.

With continued reference to FIG. 1, motion observer 100 includes at least a sensor 132 communicatively connected to the aircraft, the at least a sensor 132 configured to detect a measured state datum 136. A “measured state datum”, for the purposes of this disclosure, is one or more elements of data representing the actual motion/forces/moments/torques acting on the aircraft in the real world as a function of the at least an aircraft command 104. A measured state datum 136 includes an inertial measurement unit. An “inertial measurement unit”, for the purposes of this disclosure, is an electronic device that measures and reports a body's specific force, angular rate, and orientation of the body, using a combination of accelerometers, gyroscopes, and magnetometers, in various arrangements and combinations. Sensor 132 measures the aircraft's actual response in the real world to the at least an aircraft command 104. Sensor 132 may include a motion sensor. A “motion sensor”, for the purposes of this disclosure, is a device or component configured to detect physical movement of an object or grouping of objects. One of ordinary skill in the art would appreciate, after reviewing the entirety of this disclosure, that motion may include a plurality of types including but not limited to: spinning, rotating, oscillating, gyrating, jumping, sliding, reciprocating, or the like. Sensor 132 may include, torque sensor, gyroscope, accelerometer, torque sensor, magnetometer, inertial measurement unit (IMU), pressure sensor, force sensor, proximity sensor, displacement sensor, vibration sensor, among others. Sensor 132 may include a sensor suite which may include a plurality of sensors that may detect similar or unique phenomena. For example, in a non-limiting embodiment, sensor suite may include a plurality of accelerometers, a mixture of accelerometers and gyroscopes, or a mixture of an accelerometer, gyroscope, and torque sensor. The herein disclosed system and method may comprise a plurality of sensors in the form of individual sensors or a sensor suite working in tandem or individually. A sensor suite may include a plurality of independent sensors, as described herein, where any number of the described sensors may be used to detect any number of physical or electrical quantities associated with an aircraft power system or an electrical energy storage system. Independent sensors may include separate sensors measuring physical or electrical quantities that may be powered by and/or in communication with circuits independently, where each may signal sensor output to a control circuit such as a user graphical interface. In an embodiment, use of a plurality of independent sensors may result in redundancy configured to employ more than one sensor that measures the same phenomenon, those sensors being of the same type, a combination of, or another type of sensor not disclosed, so that in the event one sensor fails, the ability to detect phenomenon is maintained and in a non-limiting example, a user alter aircraft usage pursuant to sensor readings.

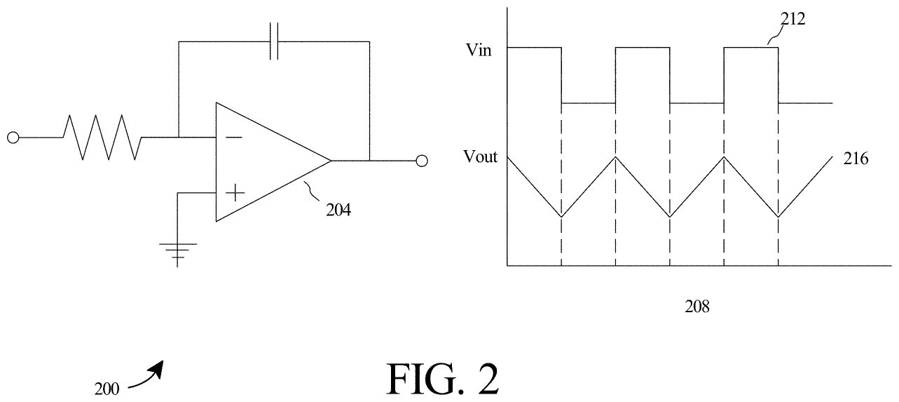

With continued reference to FIG. 1, motion observer 100 includes controller 140. Controller 140 is configured to compare the predictive datum 124, i.e., one or more elements of observer state 128, and the measured state datum 136. Controller 140 may include one or more circuit elements communicatively and electrically connected to one or more components described herein. Controller 140 may perform one or more mathematical operations, manipulations, arithmetic, machine-learning, or a combination thereof on one or more elements of data. Controller 140 generates, as a function of the comparing, generate inconsistency datum 144 wherein inconsistency datum 144 includes a mathematical function to compensate for the difference between the predictive state datum 124 and the measured state datum 136. Controller 140 is configured to compensate for the difference between predictive datum 124, which is the prediction of the behavior of the aircraft and the actual behavior of the aircraft as characterized by measured state datum 136. Controller 140 generates inconsistency datum 144 such that the inconsistency datum 144 on the subsequent control loop can be an input to plant model 120 and preemptively adjust predicted datum 124 as to more accurately predict aircraft behavior. In a non-limiting illustrative example, if plant model 120 generates the perfect predictive datum 124, such that it perfectly predicts the aircraft behavior given the at least an aircraft command 104, actuator model 108 and performance datum 112, then the measured state datum 136 detected by sensor 132 would represent the same quantities. Therefore controller 140 would generate inconsistency datum 144 that would not provide any additional compensation on the subsequent control loop. Controller 140 may include at least an integrator, which will be discussed at greater length in reference to FIG. 2.

With continued reference to FIG. 1, controller 140 may be designed to a linear approximation of a nonlinear system. Linearization is a linear approximation of a nonlinear system that is valid in a small region around an operating point. Linearization may be employed in higher order systems such that inputs and outputs may be more easily controlled using a control loop as disclosed herein. For example, and without limitations linearization can be used with feedforward control, open loop control, feedback control, among others, alone or in combination.

With continued reference to FIG. 1, controller 140 is configured to transmit the inconsistency 144 datum to the plant model 120. Controller 140 may include circuitry configured to transmit inconsistency datum 144 as analog or digital electrical signals consistent with any in the entirety of this disclosure. Controller 140 may include electronic components such as one or more receivers, transmitters, transceivers, a combination thereof, or other components not herein described configured to transmit data such as inconsistency datum 144. Controller 140 may include circuitry, components, or combinations thereof configured to transmit inconsistency datum 144 or other data not herein disclosed to the plurality of flight components communicatively connected to the aircraft.

Referring now to FIG. 2, an exemplary embodiment of an integrator utilizing an operational amplifier 204 is illustrated in schematic block diagram form. Integrator 200 may include an operational amplifier 204 configured to perform a mathematical operation of integration of a signal; output voltage may be proportional to input voltage integrated over time. An input current is offset by a negative feedback current flowing in the capacitor, which is generated by an increase in output voltage of the amplifier. The output voltage is therefore dependent on the value of input current it has to offset and the inverse of the value of the feedback capacitor. The greater the capacitor value, the less output voltage has to be generated to produce a particular feedback current flow. The input impedance of the circuit is almost zero because of the Miller effect. Hence all the stray capacitances (the cable capacitance, the amplifier input capacitance, etc.) are virtually grounded and they have no influence on the output signal. Operational amplifier 204 as used in integrator 100 may be used as part of a positive or negative feedback amplifier or as an adder or subtractor type circuit using just pure resistances in both the input and the feedback loop. As its name implies, the Op-amp Integrator is an operational amplifier 204 circuit that causes the output to respond to changes in the input voltage over time as the op-amp produces an output voltage which is proportional to the integral of the input voltage. In other words, the magnitude of the output signal is determined by the length of time a voltage is present at its input as the current through the feedback loop charges or discharges the capacitor as the required negative feedback occurs through the capacitor. Input voltage 212 may be Vin and represent the input signal to controller such as one or more of measured state datum 136 and/or predictive datum 124. Output voltage Vout 216 may represent output voltage such as one or more outputs inconsistency datum 144. When a step voltage, Vin 212 is firstly applied to the input of an integrating amplifier, the uncharged capacitor C has very little resistance and acts a bit like a short circuit allowing maximum current to flow via the input resistor, Rin as potential difference exists between the two plates. No current flows into the amplifiers input and point X is a virtual earth resulting in zero output. As the impedance of the capacitor at this point is very low, the gain ratio of X_{C}/R_{IN} is also very small giving an overall voltage gain of less than one, (voltage follower circuit). As the feedback capacitor, C begins to charge up due to the influence of the input voltage, its impedance Xc slowly increase in proportion to its rate of charge. The capacitor charges up at a rate determined by the RC time constant, (τ) of the series RC network. Negative feedback forces the op-amp to produce an output voltage that maintains a virtual earth at the op-amp's inverting input. Since the capacitor is connected between the op-amp's inverting input (which is at virtual ground potential) and the op-amp's output (which is now negative), the potential voltage, Vc developed across the capacitor slowly increases causing the charging current to decrease as the impedance of the capacitor increases. This results in the ratio of Xc/Rin increasing producing a linearly increasing ramp output voltage that continues to increase until the capacitor is fully charged. At this point the capacitor acts as an open circuit, blocking any more flow of DC current. The ratio of feedback capacitor to input resistor (X_{C}/R_{IN}) is now infinite resulting in infinite gain. The result of this high gain (similar to the op-amps open-loop gain), is that the output of the amplifier goes into saturation as shown below. (Saturation occurs when the output voltage of the amplifier swings heavily to one voltage supply rail or the other with little or no control in between). The rate at which the output voltage increases (the rate of change) is determined by the value of the resistor and the capacitor, “RC time constant”. By changing this RC time constant value, either by changing the value of the Capacitor, C or the Resistor, R, the time in which it takes the output voltage to reach saturation can also be changed for example. Controller 140 may include a double integrator, consistent with the description of an integrator with the entirety of this disclosure. Single or double integrators consistent with the entirety of this disclosure may include analog or digital circuit components.

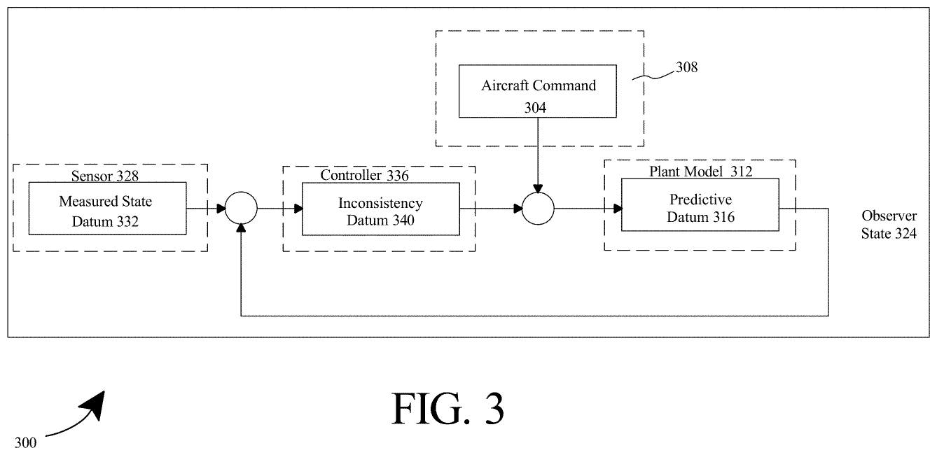

Referring now to FIG. 3, an embodiment for a system 300 for an aircraft observer configured for use in electric aircraft is presented in block diagram form. System 300 includes at least as aircraft command 304. At least an aircraft command 304 may be the same or similar to at least an aircraft command 104. System 300 includes feedforward term 308 which may be the same or similar to feedforward term 116. System 300 includes plant model 312 which may be similar to plant model 120. Plant model 312 may include an actuator model similar to or the same as actuator model 108. Plant model 312 may include one or more actuator models consistent with any actuator model as described herein. Plant model 312 may use rigid body mechanics and kinematics as previously described, or another undisclosed method of modeling three-dimensional bodies subject to flows, such as computational flow dynamics analysis, which may include flight component CFD as described previously in regard to actuator model 108. Plant model 312 is configured to generate predictive datum 316 consistent with any predictive datum as described herein such that the predictive datum represents predicted behavior of the aircraft subject to certain flows given at least an aircraft command 304. Observer state 324 may be consistent with observer state 128 wherein it may represent predicted behavior of aircraft motion. System 300 includes at least a sensor 328 configured to detect measured state datum 332 which may be consistent with the one or more sensors described in regard to sensor 132 and measured state datum 136 describing the real-world behavior of the aircraft in response to at least an aircraft command 104. System 300 includes controller 336 which may be the same or similar to controller 140 configured to generate inconsistency datum 340 which may be the same as or similar to inconsistency datum 144 which represents a compensation between how well predictive datum predicted the measured state datum. That is to say that the inconsistency datum compensates for the subsequent prediction from the plant model based on how accurately the previous plant model's prediction represented the measured state datum of the real-world aircraft.

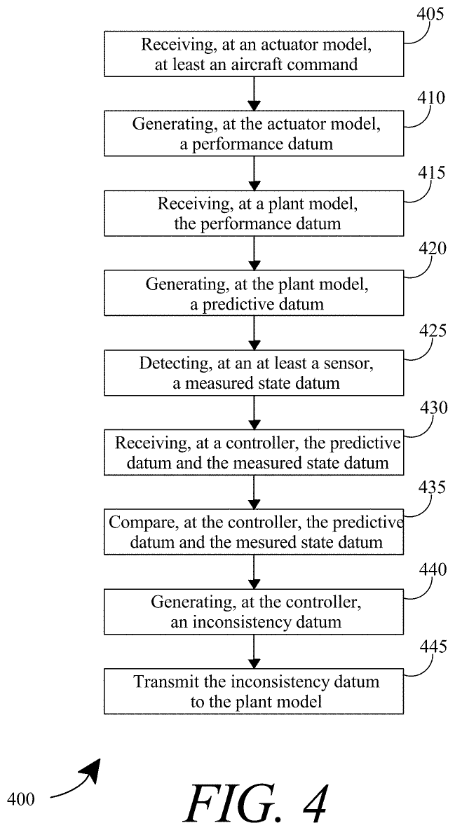

Referring now to FIG. 4, method 400 for an aircraft observer configured for use in an electric aircraft includes, at 405, receiving, at actuator model 108, at least an aircraft command 104, wherein at the at least an aircraft command includes mechanical movement of a throttle. The throttle may be consistent with any throttle as described herein.

Still referring to FIG. 4, at step 410, generating, at the actuator model 108, a performance datum 112 as a function of the at least an aircraft command 104. The actuator model 108 may be any mathematical, computational flow dynamics, or other analysis or model of the dynamics of the plurality of flight components as described herein.

Still referring to FIG. 4, at step 415, receiving, at a plant model 120, the performance datum 112, wherein the plant model 120 may be a mathematical model of the torque produced on the electric aircraft when computational fluid dynamics are applied to the plurality of flight components as described herein. Plant model 120 may be configured to utilize any quaternion attitude control or other control schema as described herein.

Still referring to FIG. 4, at step 420, generating, at the plant model 120, a predictive datum 124 as a function of the performance datum 116. The plant mode 120 may be configured to generate the predictive datum 124 as a function of a signal from at least a flight component or any other component control input as described herein.

Still referring to FIG. 4, at step 425, detecting, at an at least a sensor 132, a measured state datum 136. The at least a sensor 132 may include any sensor as described herein, include an inertial measurement unit (IMU), accelerometer, or gyroscope, without limitation.

Still referring to FIG. 4, at step 430, receiving, at controller 140, the predictive datum 124 and the measured state datum 136. The controller 140 may include at least an integrator consistent with any integrator or circuit component as described herein, including a double integrator.

Still referring to FIG. 4, at step 435, comparing, at the controller 140, the predictive datum 124 and the measured state datum 136. The controller 140 may be designed to a any linear approximation of any nonlinear system consistent with the disclosure herein described.

Still referring to FIG. 4, at step 440, generating, at the controller, an inconsistency datum 144 as a function of the comparing of the predictive datum 124 and the measured state datum 136. The comparison may be any function as described herein. The measured state datum 136 may be any measured state datum as described herein. The predictive datum 124 may be any predictive datum as described herein.

Still referring to FIG. 4, at step 445, transmitting the inconsistency datum 144 to the plant model 120. Transmitting may include any method of transmission as described herein. The plant model 120 may be any plant model as described herein. The inconsistency datum 144 may be any inconsistency datum as described herein. The inconsistency datum 144 may be transmitted to the plurality of flight components. The plurality of flight components may be any flight components as described herein.

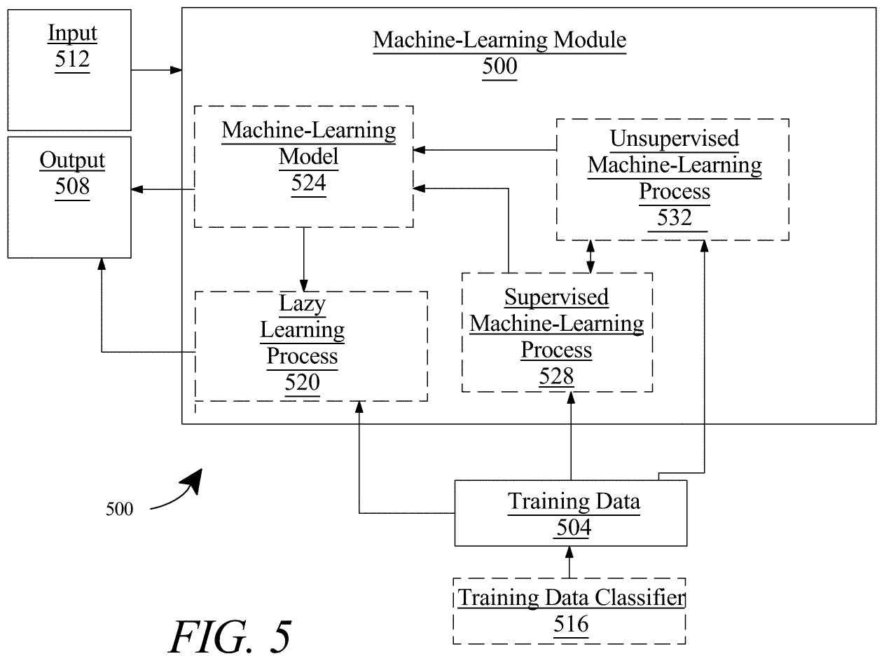

Referring now to FIG. 5, flight controller, controller 140 or another computing device or model that may utilize stored data to generate inconsistency datum 144. Stored data may be past inconsistency datums, predictive datums, measured state datums, or the like in an embodiment of the present invention. Stored data may be input by a user, pilot, support personnel, or another. Stored data may include algorithms and machine-learning processes that may generate inconsistency datum 144 considering measured state datums, predictive datums, and/or observer states. The algorithms and machine-learning processes may be any algorithm or machine-learning processes as described herein. Training data may be columns, matrices, rows, blocks, spreadsheets, books, or other suitable datastores or structures that contain correlations between past torque outputs to performance parameters. Training data may be any training data as described below. Training data may be past measurements detected by any sensors described herein or another sensor or suite of sensors in combination. Training data may be detected by onboard or offboard instrumentation designed to detect measured state datum or environmental conditions as described herein. Training data may be uploaded, downloaded, and/or retrieved from a server prior to flight. Training data may be generated by a computing device that may simulate inconsistency datums suitable for use by the flight controller, controller, or other computing devices in an embodiment of the present invention. Flight controller, controller, and/or another computing device as described in this disclosure may train one or more machine-learning models using the training data as described in this disclosure. Training one or more machine-learning models consistent with the training one or more machine learning modules as described in this disclosure.

With continued reference to FIG. 5, algorithms and machine-learning processes may include any algorithms or machine-learning processes as described herein. Training data may be columns, matrices, rows, blocks, spreadsheets, books, or other suitable datastores or structures that contain correlations between torque measurements to obstruction datums. Training data may be any training data as described herein. Training data may be past measurements detected by any sensors described herein or another sensor or suite of sensors in combination. Training data may be detected by onboard or offboard instrumentation designed to detect environmental conditions and measured state datums as described herein. Training data may be uploaded, downloaded, and/or retrieved from a server prior to flight. Training data may be generated by a computing device that may simulate predictive datums, performance datums, or the like suitable for use by the flight controller, controller 140, plant model 120, in an embodiment of the present invention. Flight controller, controller, and/or another computing device as described in this disclosure may train one or more machine-learning models using the training data as described in this disclosure.

Referring now to FIG. 5, an exemplary embodiment of a machine-learning module 500 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 504 to generate an algorithm that will be performed by a computing device/module to produce outputs 508 given data provided as inputs 512; this is in contrast to a non-machine learning software program where the commands to be executed are determined in advance by a user and written in a programming language.

Still referring to FIG. 5, “training data,” as used herein, is data containing correlations that a machine-learning process may use to model relationships between two or more categories of data elements. For instance, and without limitation, training data 504 may include a plurality of data entries, each entry representing a set of data elements that were recorded, received, and/or generated together; data elements may be correlated by shared existence in a given data entry, by proximity in a given data entry, or the like. Multiple data entries in training data 504 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 504 according to various correlations; correlations may indicate causative and/or predictive links between categories of data elements, which may be modeled as relationships such as mathematical relationships by machine-learning processes as described in further detail below. Training data 504 may be formatted and/or organized by categories of data elements, for instance by associating data elements with one or more descriptors corresponding to categories of data elements. As a non-limiting example, training data 504 may include data entered in standardized forms by persons or processes, such that entry of a given data element in a given field in a form may be mapped to one or more descriptors of categories. Elements in training data 504 may be linked to descriptors of categories by tags, tokens, or other data elements; for instance, and without limitation, training data 504 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively, or additionally, and continuing to refer to FIG. 5, training data 504 may include one or more elements that are not categorized; that is, training data 504 may not be formatted or contain descriptors for some elements of data. Machine-learning algorithms and/or other processes may sort training data 504 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 504 to be made applicable for two or more distinct machine-learning algorithms as described in further detail below. Training data 504 used by machine-learning module 500 may correlate any input data as described in this disclosure to any output data as described in this disclosure. As a non-limiting illustrative example at least a predictive datum 124 and observer state 128 may be inputs, wherein an inconsistency datum 144 is outputted.

Further referring to FIG. 5, training data may be filtered, sorted, and/or selected using one or more supervised and/or unsupervised machine-learning processes and/or models as described in further detail below; such models may include without limitation a training data classifier 516. Training data classifier 516 may include a “classifier,” which as used in this disclosure is a machine-learning model as defined below, such as a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. Machine-learning module 500 may generate a classifier using a classification algorithm, defined as a processes whereby a computing device and/or any module and/or component operating thereon derives a classifier from training data 504. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 516 may classify elements of training data to classes of deficiencies, wherein a nourishment deficiency may be categorized to a large deficiency, a medium deficiency, and/or a small deficiency.

Still referring to FIG. 5, machine-learning module 500 may be configured to perform a lazy-learning process 520 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 504. Heuristic may include selecting some number of highest-ranking associations and/or training data 504 elements. Lazy learning may implement any suitable lazy learning algorithm, including without limitation a K-nearest neighbors algorithm, a lazy naive Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 5, machine-learning processes as described in this disclosure may be used to generate machine-learning models 524. A “machine-learning model,” as used in this disclosure, is a mathematical and/or algorithmic representation of a relationship between inputs and outputs, as generated using any machine-learning process including without limitation any process as described above, and stored in memory; an input is submitted to a machine-learning model 524 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 524 may be generated by creating an artificial neural network, such as a convolutional neural network comprising an input layer of nodes, one or more intermediate layers, and an output layer of nodes. Connections between nodes may be created via the process of “training” the network, in which elements from a training data 504 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 5, machine-learning algorithms may include at least a supervised machine-learning process 528. At least a supervised machine-learning process 528, as defined herein, include algorithms that receive a training set relating a number of inputs to a number of outputs, and seek to find one or more mathematical relations relating inputs to outputs, where each of the one or more mathematical relations is optimal according to some criterion specified to the algorithm using some scoring function. For instance, a supervised learning algorithm may include at measured state datum 136 as described above as one or more inputs, inconsistency datum 144 as an output, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 504. Persons skilled in the art, upon reviewing the entirety of this disclosure, will be aware of various possible variations of at least a supervised machine-learning process 528 that may be used to determine relation between inputs and outputs. Supervised machine-learning processes may include classification algorithms as defined above.

Further referring to FIG. 5, machine learning processes may include at least an unsupervised machine-learning processes 532. An unsupervised machine-learning process, as used herein, is a process that derives inferences in datasets without regard to labels; as a result, an unsupervised machine-learning process may be free to discover any structure, relationship, and/or correlation provided in the data. Unsupervised processes may not require a response variable; unsupervised processes may be used to find interesting patterns and/or inferences between variables, to determine a degree of correlation between two or more variables, or the like.

Still referring to FIG. 5, machine-learning module 500 may be designed and configured to create a machine-learning model 524 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 5, machine-learning algorithms may include, without limitation, linear discriminant analysis. Machine-learning algorithm may include quadratic discriminate analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized tress, AdaBoost, gradient tree boosting, and/or voting classifier methods. Machine-learning algorithms may include neural net algorithms, including convolutional neural net processes.

Referring now to FIG. 6, an embodiment of an electric aircraft 600 is presented. Still referring to FIG. 6, electric aircraft 600 may include a vertical takeoff and landing aircraft (eVTOL). As used herein, a vertical take-off and landing (eVTOL) aircraft is one that can hover, take off, and land vertically. An eVTOL, as used herein, is an electrically powered aircraft typically using an energy source, of a plurality of energy sources to power the aircraft. In order to optimize the power and energy necessary to propel the aircraft. eVTOL may be capable of rotor-based cruising flight, rotor-based takeoff, rotor-based landing, fixed-wing cruising flight, airplane-style takeoff, airplane-style landing, and/or any combination thereof. Rotor-based flight, as described herein, is where the aircraft generated lift and propulsion by way of one or more powered rotors coupled with an engine, such as a “quad copter,” multi-rotor helicopter, or other vehicle that maintains its lift primarily using downward thrusting propulsors. Fixed-wing flight, as described herein, is where the aircraft is capable of flight using wings and/or foils that generate life caused by the aircraft's forward airspeed and the shape of the wings and/or foils, such as airplane-style flight.

With continued reference to FIG. 6, a number of aerodynamic forces may act upon the electric aircraft 600 during flight. Forces acting on an electric aircraft 600 during flight may include, without limitation, thrust, the forward force produced by the rotating element of the electric aircraft 600 and acts parallel to the longitudinal axis. Another force acting upon electric aircraft 600 may be, without limitation, drag, which may be defined as a rearward retarding force which is caused by disruption of airflow by any protruding surface of the electric aircraft 600 such as, without limitation, the wing, rotor, and fuselage. Drag may oppose thrust and acts rearward parallel to the relative wind. A further force acting upon electric aircraft 600 may include, without limitation, weight, which may include a combined load of the electric aircraft 600 itself, crew, baggage, and/or fuel. Weight may pull electric aircraft 600 downward due to the force of gravity. An additional force acting on electric aircraft 600 may include, without limitation, lift, which may act to oppose the downward force of weight and may be produced by the dynamic effect of air acting on the airfoil and/or downward thrust from the propulsor of the electric aircraft. Lift generated by the airfoil may depend on speed of airflow, density of air, total area of an airfoil and/or segment thereof, and/or an angle of attack between air and the airfoil. For example, and without limitation, electric aircraft 600 are designed to be as lightweight as possible. Reducing the weight of the aircraft and designing to reduce the number of components is essential to optimize the weight. To save energy, it may be useful to reduce weight of components of an electric aircraft 600, including without limitation propulsors and/or propulsion assemblies. In an embodiment, the motor may eliminate need for many external structural features that otherwise might be needed to join one component to another component. The motor may also increase energy efficiency by enabling a lower physical propulsor profile, reducing drag and/or wind resistance. This may also increase durability by lessening the extent to which drag and/or wind resistance add to forces acting on electric aircraft 600 and/or propulsors.

Referring still to FIG. 6, Aircraft may include at least a vertical propulsor 604 and at least a forward propulsor 608. A forward propulsor is a propulsor that propels the aircraft in a forward direction. Forward in this context is not an indication of the propulsor position on the aircraft; one or more propulsors mounted on the front, on the wings, at the rear, etc. A vertical propulsor is a propulsor that propels the aircraft in a upward direction; one of more vertical propulsors may be mounted on the front, on the wings, at the rear, and/or any suitable location. A propulsor, as used herein, is a component or device used to propel a craft by exerting force on a fluid medium, which may include a gaseous medium such as air or a liquid medium such as water. At least a vertical propulsor 604 is a propulsor that generates a substantially downward thrust, tending to propel an aircraft in a vertical direction providing thrust for maneuvers such as without limitation, vertical take-off, vertical landing, hovering, and/or rotor-based flight such as “quadcopter” or similar styles of flight.

With continued reference to FIG. 6, at least a forward propulsor 608 as used in this disclosure is a propulsor positioned for propelling an aircraft in a “forward” direction; at least a forward propulsor may include one or more propulsors mounted on the front, on the wings, at the rear, or a combination of any such positions. At least a forward propulsor may propel an aircraft forward for fixed-wing and/or “airplane”-style flight, takeoff, and/or landing, and/or may propel the aircraft forward or backward on the ground. At least a vertical propulsor 604 and at least a forward propulsor 608 includes a thrust element. At least a thrust element may include any device or component that converts the mechanical energy of a motor, for instance in the form of rotational motion of a shaft, into thrust in a fluid medium. At least a thrust element may include, without limitation, a device using moving or rotating foils, including without limitation one or more rotors, an airscrew or propeller, a set of airscrews or propellers such as contrarotating propellers, a moving or flapping wing, or the like. At least a thrust element may include without limitation a marine propeller or screw, an impeller, a turbine, a pump-jet, a paddle or paddle-based device, or the like. As another non-limiting example, at least a thrust element may include an eight-bladed pusher propeller, such as an eight-bladed propeller mounted behind the engine to ensure the drive shaft is in compression. Propulsors may include at least a motor mechanically coupled to the at least a first propulsor as a source of thrust. A motor may include without limitation, any electric motor, where an electric motor is a device that converts electrical energy into mechanical energy, for instance by causing a shaft to rotate. At least a motor may be driven by direct current (DC) electric power; for instance, at least a first motor may include a brushed DC at least a first motor, or the like. At least a first motor may be driven by electric power having varying or reversing voltage levels, such as alternating current (AC) power as produced by an alternating current generator and/or inverter, or otherwise varying power, such as produced by a switching power source. At least a first motor may include, without limitation, brushless DC electric motors, permanent magnet synchronous at least a first motor, switched reluctance motors, or induction motors. In addition to inverter and/or a switching power source, a circuit driving at least a first motor may include electronic speed controllers or other components for regulating motor speed, rotation direction, and/or dynamic braking. Persons skilled in the art, upon reviewing the entirety of this disclosure, will be aware of various devices that may be used as at least a thrust element.

With continued reference to FIG. 6, during flight, a number of forces may act upon the electric aircraft. Forces acting on an aircraft 600 during flight may include thrust, the forward force produced by the rotating element of the aircraft 600 and acts parallel to the longitudinal axis. Drag may be defined as a rearward retarding force which is caused by disruption of airflow by any protruding surface of the aircraft 600 such as, without limitation, the wing, rotor, and fuselage. Drag may oppose thrust and acts rearward parallel to the relative wind. Another force acting on aircraft 600 may include weight, which may include a combined load of the aircraft 600 itself, crew, baggage and fuel. Weight may pull aircraft 600 downward due to the force of gravity. An additional force acting on aircraft 600 may include lift, which may act to oppose the downward force of weight and may be produced by the dynamic effect of air acting on the airfoil and/or downward thrust from at least a propulsor. Lift generated by the airfoil may depends on speed of airflow, density of air, total area of an airfoil and/or segment thereof, and/or an angle of attack between air and the airfoil.

With continued reference to FIG. 6, at least a portion of an electric aircraft may include at least a propulsor. A propulsor, as used herein, is a component or device used to propel a craft by exerting force on a fluid medium, which may include a gaseous medium such as air or a liquid medium such as water. In an embodiment, when a propulsor twists and pulls air behind it, it will, at the same time, push an aircraft forward with an equal amount of force. The more air pulled behind an aircraft, the greater the force with which the aircraft is pushed forward. Propulsor may include any device or component that consumes electrical power on demand to propel an electric aircraft in a direction or other vehicle while on ground or in-flight.

With continued reference to FIG. 6, in an embodiment, at least a portion of the aircraft may include a propulsor, the propulsor may include a propeller, a blade, or any combination of the two. The function of a propeller is to convert rotary motion from an engine or other power source into a swirling slipstream which pushes the propeller forwards or backwards. The propulsor may include a rotating power-driven hub, to which are attached several radial airfoil-section blades such that the whole assembly rotates about a longitudinal axis. The blade pitch of the propellers may, for example, be fixed, manually variable to a few set positions, automatically variable (e.g. a “constant-speed” type), or any combination thereof. In an embodiment, propellers for an aircraft are designed to be fixed to their hub at an angle similar to the thread on a screw makes an angle to the shaft; this angle may be referred to as a pitch or pitch angle which will determine the speed of the forward movement as the blade rotates.

With continued reference to FIG. 6, in an embodiment, a propulsor can include a thrust element which may be integrated into the propulsor. The thrust element may include, without limitation, a device using moving or rotating foils, such as one or more rotors, an airscrew or propeller, a set of airscrews or propellers such as contra-rotating propellers, a moving or flapping wing, or the like. Further, a thrust element, for example, can include without limitation a marine propeller or screw, an impeller, a turbine, a pump-jet, a paddle or paddle-based device, or the like.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

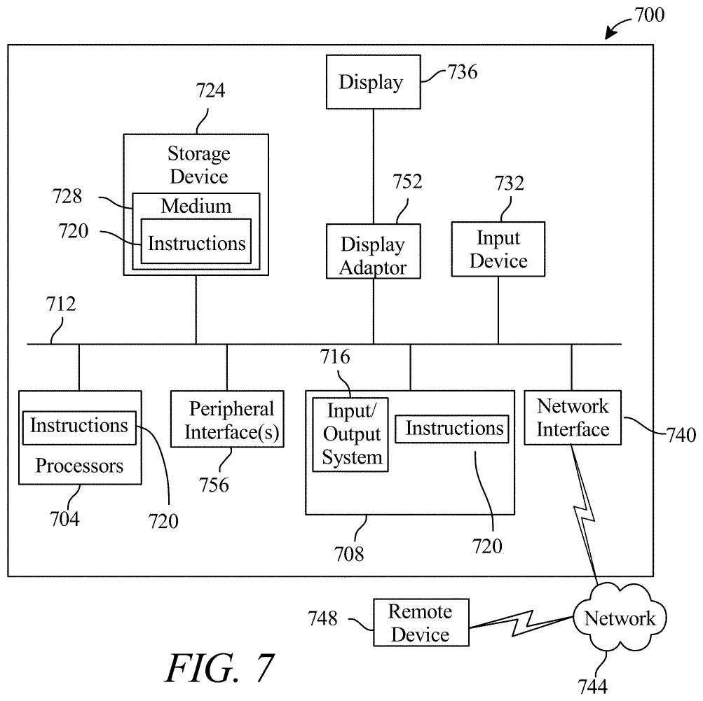

FIG. 7 shows a diagrammatic representation of one embodiment of a computing device in the exemplary form of a computer system 700 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 700 includes a processor 704 and a memory 708 that communicate with each other, and with other components, via a bus 712. Bus 712 may include any of several types of bus structures including, but not limited to, a memory bus, a memory controller, a peripheral bus, a local bus, and any combinations thereof, using any of a variety of bus architectures.

Processor 704 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 704 may be organized according to Von Neumann and/or Harvard architecture as a non-limiting example. Processor 704 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), and/or system on a chip (SoC).

Memory 708 may include various components (e.g., machine-readable media) including, but not limited to, a random-access memory component, a read only component, and any combinations thereof. In one example, a basic input/output system 716 (BIOS), including basic routines that help to transfer information between elements within computer system 700, such as during start-up, may be stored in memory 708. Memory 708 may also include (e.g., stored on one or more machine-readable media) instructions (e.g., software) 720 embodying any one or more of the aspects and/or methodologies of the present disclosure. In another example, memory 708 may further include any number of program modules including, but not limited to, an operating system, one or more application programs, other program modules, program data, and any combinations thereof.

Computer system 700 may also include a storage device 724. Examples of a storage device (e.g., storage device 724) include, but are not limited to, a hard disk drive, a magnetic disk drive, an optical disc drive in combination with an optical medium, a solid-state memory device, and any combinations thereof. Storage device 724 may be connected to bus 712 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 724 (or one or more components thereof) may be removably interfaced with computer system 700 (e.g., via an external port connector (not shown)). Particularly, storage device 724 and an associated machine-readable medium 728 may provide nonvolatile and/or volatile storage of machine-readable instructions, data structures, program modules, and/or other data for computer system 700. In one example, software 720 may reside, completely or partially, within machine-readable medium 728. In another example, software 720 may reside, completely or partially, within processor 704.

Computer system 700 may also include an input device 732. In one example, a user of computer system 700 may enter commands and/or other information into computer system 700 via input device 732. Examples of an input device 732 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 732 may be interfaced to bus 712 via any of a variety of interfaces (not shown) including, but not limited to, a serial interface, a parallel interface, a game port, a USB interface, a FIREWIRE interface, a direct interface to bus 712, and any combinations thereof. Input device 732 may include a touch screen interface that may be a part of or separate from display 736, discussed further below. Input device 732 may be utilized as a user selection device for selecting one or more graphical representations in a graphical interface as described above.

A user may also input commands and/or other information to computer system 700 via storage device 724 (e.g., a removable disk drive, a flash drive, etc.) and/or network interface device 740. A network interface device, such as network interface device 740, may be utilized for connecting computer system 700 to one or more of a variety of networks, such as network 744, and one or more remote devices 748 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 744, may employ a wired and/or a wireless mode of communication. In general, any network topology may be used. Information (e.g., data, software 720, etc.) may be communicated to and/or from computer system 700 via network interface device 740.

Computer system 700 may further include a video display adapter 752 for communicating a displayable image to a display device, such as display device 736. Examples of a display device include, but are not limited to, a liquid crystal display (LCD), a cathode ray tube (CRT), a plasma display, a light emitting diode (LED) display, and any combinations thereof. Display adapter 752 and display device 736 may be utilized in combination with processor 704 to provide graphical representations of aspects of the present disclosure. In addition to a display device, computer system 700 may include one or more other peripheral output devices including, but not limited to, an audio speaker, a printer, and any combinations thereof. Such peripheral output devices may be connected to bus 712 via a peripheral interface 756. Examples of a peripheral interface include, but are not limited to, a serial port, a USB connection, a FIREWIRE connection, a parallel connection, and any combinations thereof

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An aircraft motion observer configured for use in electric aircraft, the aircraft motion observer comprising:
a computing device, the computing device configured to implement:
an actuator model, the actuator model configured to:
receive at least an aircraft command associated with an actual electric aircraft, wherein the aircraft command comprises a desired change in aircraft trajectory, wherein the desired change in aircraft trajectory is implementable by each actual flight component of a plurality of actual flight components of the actual electric aircraft; and
generate a performance datum for each flight component of a plurality of flight components as a function of the at least an aircraft command, wherein the performance datum for each flight component includes a resultant torque for each flight component of the plurality of flight components;
a plant model, the plant model configured to generate a predictive datum for each flight component of the plurality of flight components as a function of the performance datum, wherein generating the predictive datum for each flight component includes applying computational fluid dynamics to each flight component of the plurality of flight components;
at least a sensor communicatively connected to the actual electric aircraft, the at least a sensor configured to detect a measured state datum for each actual flight component of the plurality of actual flight components of the actual electric aircraft; and
a controller communicatively connected to the at least a sensor, the controller configured to:
receive the predictive datum for each flight component and the measured state datum for each actual flight component
compare the predictive datum for each flight component and the measured state datum for each actual flight component;
generate an inconsistency datum, as a function of the comparing, wherein each inconsistency datum comprises a difference between each predictive datum and each measured state datum;
transmit each inconsistency datum to the plant model;
transmit each inconsistency datum to the plurality of actual flight components of the actual electric aircraft, wherein each inconsistency datum is transmitted as an electrical signal, and wherein the plurality of actual flight components comprises at least a propulsor of the actual electric aircraft and
adjust, preemptively, a subsequent predictive datum of the plant model, as a function of at least one of the generated inconsistency datums, to improve prediction of actual aircraft behavior.

2. The system of claim 1, wherein at least an aircraft command comprises a mechanical movement of a throttle.

3. (canceled)

4. The system of claim 1, wherein the at least a sensor comprises an inertial measurement unit.

5. The system of claim 1, wherein the actuator model includes a mathematical model of the dynamics of the plurality of flight components.

6. The system of claim 1, wherein the plant model includes a mathematical model of a torque produced by the electric aircraft when fluid mechanics are applied to each flight component of the plurality of flight components.

7. The system of claim 1, wherein the controller comprises at least an integrator.

8. The system of claim 1, wherein the plant model is configured to utilize dynamic modeling.

9. (canceled)

10. The system of claim 1, wherein the plant model generates the predictive datum as a function of a signal from at least a flight component.

11. A method for an aircraft motion observer configured for use in an electric aircraft, the method comprising:
implementing, at a computing device, an actuator model and a plant model;
receiving, at the actuator model, at least an aircraft command associated with an actual electric aircraft, wherein the desired change in aircraft trajectory of is implementable by each actual flight component of a plurality of actual flight components of the actual electric aircraft;
generating, at the actuator model, a performance datum for each flight component of a plurality of flight components as a function of the at least an aircraft command, wherein generating the performance datum for each flight component includes generating a resultant torque for each flight component of the plurality of flight components;
receiving, at a plant model, the performance datum for each flight component of the plurality of flight components;
generating, at the plant model, a predictive datum for each flight component of the plurality of flight components as a function of the performance datum, wherein generating the predictive datum for each flight component includes applying computational fluid dynamics to each flight component of the plurality of flight components;
detecting, at an at least a sensor communicatively connected to the actual electric aircraft, a measured state datum for each actual flight component of the plurality of actual flight components of the actual electric aircraft;
receiving, at a controller communicatively connected to the at least a sensor, the predictive datum for each flight component and the measured state datum for each actual flight component;
comparing, at the controller, the predictive datum for each flight component and the measured state datum for each actual flight component;
generating, at the controller, an inconsistency datum as a function of the comparing, wherein each inconsistency datum comprises a difference between each predictive datum and each measured state datum; and
transmitting, at the controller, each inconsistency datum to the plant model,
transmitting, at the controller, each inconsistency datum to the plurality of actual flight components of the actual electric aircraft, wherein each inconsistency datum is transmitted as an electrical signal, and wherein the plurality of actual flight components comprises at least a propulsor of the actual electric aircraft and
adjusting, preemptively, at the controller, a subsequent predictive datum of the plant model, as a function of at least one of the generated inconsistency datums, to improve prediction of actual aircraft behavior.

12. The method of claim 11, wherein at least an aircraft command comprises mechanical movement of a throttle.

13. (canceled)

14. The method of claim 11, wherein the at least a sensor comprises an inertial measurement unit.

15. The method of claim 11, wherein the actuator model is a mathematical model of the dynamics of the plurality of flight components.

16. The method of claim 11, wherein the plant model is a mathematical model of a torque produced by the electric aircraft when fluid mechanics are applied to each flight component of the plurality of flight components.

17. The method of claim 11, wherein the controller comprises at least an integrator.

18. The method of claim 11, wherein the plant model is configured to utilize dynamic modeling.

19. (canceled)

20. The method of claim 11, wherein the plant model generates the predictive datum as a function of a signal from at least a flight component.
